(19) United States
(12) Patent Application Publication
(10) Pub. No.: US 2012/0006225 A1
(43) Pub. Date: Jan. 12, 2012

(54) INK COMPOSITION

(75) Inventors: Kazuaki TSUKIANA, Axunina-shi (JP); Takashi OYANAGI, Matsumato-shi (JP)

(73) Assignee: SEIKO EPSON CORPORATION

(21) Appl. No.: 13/178,554

(22) Filed: Jul. 8, 2011

(30) Foreign Application Priority Data
Jul. 9, 2010 (JP) 2010-156694

(51) Int. Cl. C09D 11/02

(52) U.S. Cl. 106/31.86; 106/31.9

(57) ABSTRACT

An ink composition contains an organic solvent, a metal pigment, and a silicone oil having a kinematic viscosity of 2 to 30 cSt in a proportion of 0.01% by mass or more and less than 0.5% by mass relative to the total mass of the ink composition. The value of expression (1) is 0.1 or more and less than 9.0:

[Kinematic viscosity of silicone oil on a cSt basis]×[silicone oil content on a percent-by-mass basis] (1)

Priority is claimed under 35 U.S.C §119 to Japanese Application No. 2010-156694 filed on Jul. 9, 2010, which is hereby incorporated by reference in its entirety.

### BACKGROUND

1. Technical Field

The present invention relates to an ink composition.

2. Related Art

There have been many applications of ink jet printing in recent years. One of the applications is metallic printing. In order to achieve high-quality metallic printing, it is important to use an ink composition having a high degree of metallic luster. Accordingly, an ink composition exhibiting superior metallic luster is desired.

For example, the present inventors have proposed an ink composition containing a silicone surfactant in JP-A-2008-174712. This ink composition has a high degree of metallic luster.

It is however desired that this ink composition be further improved to avoid bleeding out on the recording medium and to enhance the metallic luster in practice.

### SUMMARY

An advantage of some aspects of the invention is that it provides an ink composition that can avoid bleeding out on the recording medium and exhibit still higher metallic luster than known ink compositions.

The present inventors have conducted intensive research to solve the above issue. As a result, the inventors have found that the use of an ink composition containing a specific amount of silicone oil having a kinematic viscosity is effective in solving the issue, and consequently have accomplished the invention.

According to an aspect of the invention, an ink composition is provided which contains an organic solvent, a metal pigment, and a silicone oil having a kinematic viscosity of 2 to 30 cSt in a proportion of 0.01% by mass or more and less than 0.5% by mass relative to the total amount of the ink composition. In the ink composition, the value of expression (1) is 0.1 or more and less than 9.0:

[Kinematic viscosity of silicone oil on a cSt basis]×[silicone oil content on a percent-by-mass basis] (1)

Preferably, the silicone oil has a kinematic viscosity of 2 to 10 cSt at 25° C.

The organic solvent may be a mixture containing at least two compounds selected from the group consisting of alkylene glycol dialkyl ethers, alkylene glycol monoalkyl ethers, and lactones.

In this instance, the organic solvent may contain diethylene glycol diethyl ether, γ-butyrolactone, tetraethylene glycol monomethyl ether, and tetraethylene glycol monobutyl ether.

The silicone oil may contain at least one of dimethyl silicone oil and methyl hydrogen silicone oil.

The metal pigment may contain at least one of aluminum and aluminum alloys.

The metal pigment may be prepared by pulverizing a vapor-deposited metal film.

The ink composition may have a surface tension of 20 to 50 mN/m.

The ink composition may have a viscosity of 8 mPa·s or less at 20° C.

### DESCRIPTION OF EXEMPLARY EMBODIMENTS

An embodiment of the invention will now be described in detail. The invention is not limited to the following embodiment, and various modifications may be made within the scope and spirit of the invention.

### Ink Composition

An embodiment of the invention relates to an ink composition. The ink composition contains an organic solvent, a metal pigment, and a silicone oil having a kinematic viscosity of 2 to 30 cSt in a proportion of 0.01% by mass or more and less than 0.5% by mass relative to the total amount of the ink composition. In the ink composition, the value of expression (1) is 0.1 or more and less than 9.0.

[Kinematic viscosity of silicone oil (cSt)]×[silicone oil content (mass %)] (1)

In this instance, the kinematic viscosity is a measurement at 25° C.

The ink composition can be advantageously used for further enhancing the quality of metallic printing, which is one of the applications of ink jet printing. The constituents of the ink composition will be described below.

### Silicone Oil

The silicone oil contained in the ink composition of the present embodiment has a kinematic viscosity of 2 to 30 cSt, and otherwise not limited. Examples of the silicone oil include dimethyl silicone oil, methylphenyl silicone oil, chlorophenyl silicone oil, methyl hydrogen silicone oil, alkyl-modified silicone oil, fluorine-modified silicone oil, polyether-modified silicone oil, alcohol-modified silicone oil, amino-modified silicone oil, epoxy-modified silicone oil, epoxy polyether-modified silicone oil, phenol-modified silicone oil, carboxyl-modified silicone oil, mercapto-modified silicone oil, acryl/methacryl-modified silicone oil, and α-methyl styrene-modified silicone oil. These silicone oils may be used alone or in a mixture.

Preferably, the silicone oil contains at least one of dimethyl silicone oil and methyl hydrogen silicone oil. Such an ink composition does not bleed out on the recording medium, and can exhibit high metallic luster and high ejection stability, particularly superior metallic luster.

The silicone oil content in the total mass of the ink composition (100% by mass) is 0.01% by mass or more and less than 0.5% by mass, preferably 0.01% to 0.3% by mass, and particularly preferably 0.05% to 0.2% by mass.

Also, the silicone oil preferably has a kinematic viscosity (measured with Ubbelohde viscometer in accordance with ASTM D 445-46T) of 2 to 30 cSt, more preferably 2 to 10 cSt, at 25° C. In addition, the silicone oil content in the ink composition is preferably 0.01% to 0.2% by mass, and more preferably 0.05% to 0.2% by mass. In the description, 1 cSt is 1 mm²/s.

Furthermore, the value of the above expression (1) is 0.1 cSt·mass % or more and less than 9.0 cSt·mass %, preferably 0.1 to 6.0 cSt·mass %), and more preferably 0.1 to 2.0 cSt·mass %.

The ink composition satisfying the above conditions does not bleed out on the recording medium, and can exhibit high metallic luster and high ejection stability, particularly superior metallic luster.

### Metal Pigment

The metal pigment in the ink composition of the present embodiment is preferably prepared by pulverizing a vapor-deposited metal film, and is preferably in the form of flat particles. In the following description, the flat particles have main surfaces having a long diameter a and a short diameter b, and have a thickness d.

The flat particle mentioned herein refers to a particle having a substantially even surface (main surface) and a substantially uniform thickness (d). By pulverizing a vapor-deposited metal film to prepare flat particles, the resulting metal particles have substantially even surfaces and a substantially uniform thickness. Therefore, the long diameter of the main surface of the flat particle can be defined as a, the short diameter can be defined as b, and the thickness can be defined as d.

The main surface may have an oval shape defined by a long diameter (a) and a short diameter (b).

An “equivalent circle diameter” is the diameter of a circle having the same projected area as the area formed by projecting the main surface of a flat particle of the metal pigment in the thickness (d) direction of the metal pigment particle. For example, if the main surface of the flat particle of the metal pigment is polygonal, the plane formed by projecting the polygonal shape in the thickness (d) direction is converted into a circle, and the diameter of the circle is defined as the equivalent circle diameter of the flat particle of the metal pigment.

The 50% average particle size R50 in terms of the equivalent circle diameter obtained from the areas of the main surfaces of the flat particles is preferably 0.5 to 3 μm, more preferably 0.75 to 2 μm, from the viewpoint of high metallic luster and good printing stability. If the 50% average particle size R50 is less than 0.5 μm, the glossiness is insufficient. In contrast, if the 50% average particle size R50 is more than 3 μm, the printing stability is degraded.

In addition, the 50% average particle size R50 in terms of the equivalent circle diameter and the thickness d preferably have the relationship R50/d>5, from the viewpoint of ensuring superior metallic luster. If R50/d is 5 or less, the glossiness is insufficient.

Furthermore, the maximum particle size Rmax in terms of the equivalent circle diameter obtained from the areas of the main surfaces of the flat particles is preferably 10 μm or less, from the viewpoint of preventing ink jet recording apparatuses from being clogged with the ink composition. By controlling the Rmax to 10 μm or less, the nozzles of the ink jet recording apparatus and the mesh filter or the like provided in the ink flow channel can be prevented from being clogged.

The metal pigment is not particularly limited as long as it exhibits metallic luster or the like. Preferably, the metal pigment is made of aluminum or an aluminum alloy, or silver or a silver alloy. More preferably, the metal pigment is made of aluminum or an aluminum alloy from the viewpoints of cost efficiency and ensuring a superior metallic luster. If an aluminum alloy is used, the metal element or nonmetal element that can be combined with aluminum is not particularly limited as long as it has a metallic luster or a similar function, and examples of such an element include silver, gold, platinum, nickel, chromium, tin, zinc, indium, titanium, and copper. At least one of simple substances and alloys of these elements, and mixtures of simple substances and alloys is preferably used.

In a method for preparing the metal pigment, for example, a multilayer structure (hereinafter referred to as a pigment material) of a releasing resin layer and a metal or alloy layer formed in that order on the surface of a base sheet is split at the interface between the metal or alloy layer and the releasing resin layer so that the metal or alloy layer is peeled from the base sheet, and the metal or alloy layer is pulverized into flat particles. The resulting flat particles are screened to select flat particles having a sphere-equivalent 50% average particle size (D50) of 0.8 to 1.2 measured by a below-described light scattering method. Alternatively, it is preferable that flat particles satisfying the following conditions be screened: when the prepared flat particles have main surfaces having a long diameter a and a short diameter b and have a thickness d, the 50% average particle size R50 calculated from the areas of the main surfaces of the prepared flat particles is 0.5 to 3 μm and the flat particles satisfy the relationship R50/d>5.

The sphere-equivalent 50% average particle size is measured and determined by a light scattering method as below. Specifically, diffracted or scattered light generated by irradiating particles in a disperse medium with light is measured with detectors disposed at the front, side and rear of the particles. The 50% average particle size is defined by the intersection of the cumulative percentage distribution curve of measured particle sizes and a line representing a cumulative percentage of 50%.

The above sphere-equivalent average particle size refers to the average particle size calculated from measurement results with the assumption that particles, which are naturally indefinite in shape, are spherical. The measuring apparatus may be, for example, a laser diffraction/scattering particle size distribution analyzer LMS-2000e manufactured by Seishin Enterprise. When the sphere-equivalent 50% average particle size (D50) measured by the light-scattering method is within the above range, a coating having a superior metallic luster can be formed on printed matter, and in addition, the ink can be ejected stably from nozzles.

The long diameter a, short diameter b and equivalent circle diameter of the main surfaces of the flat particles of the metal pigment can be measured with a particle image analyzer. For example, a flow particle image analyzer FPIA-2100, FPIA-3000 or FPIA-3000S (manufactured by Sysmex Corporation) may be used as the particle image analyzer.

The particle size distribution (CV value) of the flat particles of the metal pigment can be obtained from the following equation (2):

CV value=(standard deviation of particle size distribution/average particle size)×100 (2)

The CV value is preferably 60 or less, more preferably 50 or less, and still more preferably 40 or less. By selecting a metal pigment having a CV value of 60 or less, the effect of achieving superior printing stability can be produced.

Preferably, the metal or alloy layer is formed by vacuum vapor deposition, ion plating, or sputtering.

The thickness of the metal or alloy layer is preferably in the range of 5 to 100 nm, and more preferably in the range of 20 to 100 nm, and these methods can form a metal or alloy layer having a thickness in these preferred ranges. By forming a metal or alloy layer having a thickness of 5 nm or more, the reflectivity and the brilliance of the pigment can be increased to enhance the performance of the metal pigment. Also, by forming a metal or alloy layer having a thickness of 100 nm or less, the resulting pigment ensures a dispersion stability without increasing the apparent specific gravity.

The releasing resin layer of the pigment material acts as an undercoat layer of the metal or alloy layer and as a releasing layer for making it easy to peel the metal or alloy layer from the base sheet. The resin used in the releasing resin layer is preferably at least one selected from the group consisting of polyvinyl alcohol, polyvinyl butyral, polyethylene glycol, polyacrylic acid, polyacrylamide, cellulose derivatives such as cellulose acetate butyrate (CAB), acrylic polymers, and modified nylon resins.

A solution containing at least one of these resins is applied onto a base sheet and dried, thus forming the releasing resin layer. The solution may further contain a viscosity adjuster or other additives.

For applying the solution to form the releasing resin layer, a conventional method can be used, such as gravure coating, roll coating, blade coating, extrusion coating, dip coating, or spin coating. After drying the coating, the surface of the releasing resin layer may be planarized by calendaring, if necessary.

The thickness of the releasing resin layer is not particularly limited, and is preferably 0.5 to 50 μm, more preferably 1 to 10 μm. If the thickness is less than 0.5 μm, the amount of resin to be dispersed is insufficient. If the thickness is more than 50 μm, the metal or alloy layer is liable to separate at the interface when the pigment material is rolled.

Examples of the base sheet include, but are not limited to, polyester films such as those of polytetrafluoroethylene, polyethylene, polypropylene, and polyethylene terephthalate; polyamide films such as those of nylon 66 and nylon 6; and other releasable films such as those of polycarbonate, triacetate, and polyimide. Polyethylene terephthalate and its copolymers are preferably used for the base sheet.

The thickness of the base sheet is not particularly limited, but is preferably 10 to 150 μm. A base sheet having a thickness of 10 μm or more can be handled without problems in the manufacturing process. A base sheet having a thickness of 150 μm or less is so flexible as can be rolled without problems with separation.

The metal or alloy layer may be formed between protective layers as disclosed in JP-A-2005-68250. The protective layer can be a silicon oxide layer or a protective resin layer.

The silicon oxide layer is not particularly limited as long as it contains silicon oxide. Preferably, the silicon oxide layer is formed of a silicon alkoxide, such as tetraalkoxysilane, or its polymer by a sol-gel method.

A solution of a silicon alkoxide or its polymer in an alcohol is applied and heated to form a silicon oxide coating.

The protective resin layer is not particularly limited as long as it is made of a resin not dissolved in disperse media. Examples of such a resin include polyvinyl alcohols, polyethylene glycols polyacrylic acids, polyacrylamides, and cellulose derivatives. Preferably, the protective resin layer is formed of a polyvinyl alcohol or a cellulose derivative.

An aqueous solution containing at least one of those resins is applied and dried to form a protective resin layer. An additive, such as a viscosity adjuster, may be added to the aqueous solution.

The solution of silicon oxide or resin is applied by the same method as in the formation of the releasing resin layer.

The thickness of the protective layer is not particularly limited, but is preferably in the range of 50 to 150 nm. If the thickness is less than 50 nm, the protective layer does not have a sufficient mechanical strength. If the thickness is more than 150 nm, it is too strong to be pulverized and dispersed, and in addition, may cause separation at the interface with the metal or alloy layer.

A color material layer may be formed between the protective layer and the metal or alloy layer, as disclosed in JP-A-2005-68251.

The color material layer is intended to produce a desired color combined pigment, and is not particularly limited as long as it can contain a color material capable of imparting a desired color and hue in addition to metallic luster and brilliance to the metal pigment. Either a dye or a pigment may be used as the color material of the color material layer. Any known dye or pigment can be used as needed.

The “pigment” used in the color material layer refers to the pigment defined in the field of general pigment chemistry, including natural pigment, synthetic organic pigment and synthetic inorganic pigment, and is different from the pigment prepared from the multilayer structure of the pigment material of the present embodiment.

Preferably, the color material layer is formed by, but not limited to, coating.

If the color material in the color material layer is a pigment, it is preferable that the color material layer further contain a resin for dispersing the color material. Preferably, the resin for dispersing the color material is dissolved or dispersed in a solvent together with the pigment and optionally other additives. The solution is spin-coated to form a liquid coating, and the coating is dried to form a resin thin film.

Preferably, both the color material layer and the protective layers are formed by coating in the process for preparing the pigment material, from the viewpoint of work efficiency.

The multilayer structure of the pigment material may have a different structure in which the releasing resin layer, the metal or alloy layer, and the protective layer are repeated several times. In this instance, the total thickness of the multilayer structure including the plurality of metal or alloy layers, that is, the thickness of the structure not including the base sheet or the releasing resin layer (metal or alloy layer-releasing resin layer-metal or alloy layer, or releasing resin layer-metal or alloy layer) is preferably 5000 nm or less. When this thickness is 5000 nm or less, the pigment material can be rolled without cracks or separation, and is thus superior in storage stability. Also, the resulting pigment exhibits superior brilliance and is thus favorable.

The pigment material may have, but is not limited to, a structure in which a multilayer structure including the releasing resin layer and the metal or alloy layer in that order is disposed on both surfaces of the base sheet.

The base sheet can be removed by any technique, and preferably, the following methods can be applied. A liquid (solvent) may be jetted onto the pigment material, and then the metal or alloy layer is scraped out of the pigment material. Alternatively, the pigment material may be immersed in a liquid. The pigment material may be sonicated simultaneously with being immersed in a liquid, and the thus peeled pigment is pulverized. These techniques allow the collection of the liquid used for removing the base sheet as well as the peeled metal or alloy layer. The liquid (solvent) used for the removal may be a glycol ether solvent or a lactone solvent, or a mixture of these solvents.

For pulverizing the peeled metal or alloy layer into fine particles, any known method using a ball mill, a bead mill, ultrasonic waves or a jet mill can be applied without particular limitation. Thus the metal pigment can be prepared.

The particles of the resulting pigment have the releasing resin layer acting as a protective colloid. Accordingly, a stable pigment-dispersed liquid can be prepared by simply dispersing the pigment in a solvent. In the ink composition containing the pigment, the resin of the releasing resin layer has adhesion to the recording medium, such as paper.

In the present embodiment, the metal pigment content in the ink composition is preferably 0.1% to 3.0% by mass, more preferably 0.5% to 2.0% by mass, if only one ink composition in an ink set is a metallic ink. If the metal pigment content in the ink composition is 0.5% by mass or more and less than 1.7% by mass, a half mirror-like glossy surface or glossy texture can be produced by ejecting an amount of ink insufficient to cover the print surface. In this instance, a texture through which the background seems to be seen can be printed. Also, a metallic luster surface superior in glossiness can be formed by ejecting an amount of ink sufficient to cover the print surface. Accordingly, the ink composition is suitable, for example, for forming a half mirror image on a transparent recording medium, or for expressing a highly glossy surface having a metallic luster.

If the metal pigment content in the ink composition is in the range of 1.7% to 2.0% by mass, the metal pigment is deposited on the print surface in a random manner and, accordingly, can produce a metallic luster surface seeming to be matt, not producing high glossiness. Thus, it is suitable to form, for example, a shielding layer on a transparent recording medium.

The ink composition of the present embodiment may contain a disperse medium to disperse the metal pigment. Examples of such a disperse medium include, but are not limited to, glycol ethers, such as diethylene glycol diethyl ether, triethylene glycol monobutyl ether, dipropylene glycol dimethyl ether, dipropylene glycol diethyl ether, and ethylene glycol monoallyl ethers; ether acetates, such as propylene glycol methyl ether acetate; lactones, such as γ-butyrolactone; and alcohols, such as isopropyl alcohol.

### Organic Solvent

The ink composition contains a solvent, and the solvent is not particularly limited, but is preferably a polar organic solvent. Examples of the polar solvent include, but are not limited to, alcohols, such as methyl alcohol, ethyl alcohol, propyl alcohol, butyl alcohol, isopropyl alcohol, and fluoroalcohol; ketones, such as acetone, methyl ethyl ketone, and cyclohexanone; carboxylic acid esters, such as methyl acetate, ethyl acetate, propyl acetate, butyl acetate, methyl propionate, and ethyl propionate; and ethers, such as diethyl ether, dipropyl ether, tetrahydrofuran, and dioxane.

Preferably, the organic solvent contains at least one alkylene glycol alkyl ether, which is liquid at room temperature and normal pressure.

Alkylene glycol alkyl ethers include ethylene glycol ethers and propylene glycol ethers, each containing an aliphatic group, such as methyl, n-propyl, isopropyl, n-butyl, isobutyl, hexyl, or 2-ethylhexyl, or allyl or phenyl having a double bond. Since alkylene glycol alkyl ethers are colorless and odorless and include the ether group and the hydroxy group in their molecules, they have both the characteristics as an alcohol and an ether and are liquid at room temperature. Also, alkylene glycol alkyl ethers include monoalkyl ethers prepared by substituting only one of the hydroxy groups and dialkyl ethers prepared by substituting both hydroxy groups. These alkylene glycol ethers may be used in combination.

Preferably, the organic solvent is a mixture containing at least two selected from the group consisting of alkylene glycol dialkyl ethers, alkylene glycol monoalkyl ethers and lactones.

Alkylene glycol monoalkyl ethers include ethylene glycol monomethyl ether, ethylene glycol monoethyl ether, ethylene glycol monoisopropyl ether, ethylene glycol monobutyl ether, ethylene glycol monohexyl ether, ethylene glycol monophenyl ether, diethylene glycol monomethyl ether, diethylene glycol monoethyl ether, diethylene glycol monobutyl ether, diethylene glycol dimethyl ether, diethylene glycol diethyl ether, triethylene glycol monomethyl ether, triethylene glycol monoethyl ether, triethylene glycol monobutyl ether, tetraethylene glycol monomethyl ether, tetraethylene glycol monoethyl ether, tetraethylene glycol monobutyl ether, propylene glycol monomethyl ether, propylene glycol monoethyl ether, dipropylene glycol monomethyl ether, and dipropylene glycol monoethyl ether.

Alkylene glycol dialkyl ethers include ethylene glycol dimethyl ether, ethylene glycol diethyl ether, ethylene glycol dibutyl ether, diethylene glycol dimethyl ether, diethylene glycol diethyl ether, diethylene glycol dibutyl ether, triethylene glycol dimethyl ether, triethylene glycol diethyl ether, triethylene glycol dibutyl ether, tetraethylene glycol dimethyl ether, tetraethylene glycol diethyl ether, tetraethylene glycol dibutyl ether, propylene glycol dimethyl ether, propylene glycol diethyl ether, dipropylene glycol dimethyl ether, and dipropylene glycol diethyl ether.

Exemplary lactones include γ-butyrolactone, δ-valerolactone, and ε-caprolactone.

By appropriately selecting the solvent, the resulting ink composition can certainly accrue advantages of some aspects of the invention. In particular, a combination of diethylene glycol diethyl ether, at least one of γ-butyrolactone and tetraethylene glycol dimethyl ether, and tetraethylene glycol monobutyl ether is more preferably used as the organic solvent.

If this combination of organic solvents is used, the diethylene glycol diethyl ether content in the ink composition is preferably 60% by mass or more, more preferably 65% by mass or more, still more preferably 70% by mass or more, and particularly 70.1% by mass or more. The upper limit of the diethylene glycol diethyl ether content is preferably 80% by mass, more preferably 75% by mass, and still more preferably 72% by mass. The total content of γ-butyrolactone and tetraethylene glycol dimethyl ether in the ink composition is preferably 24% to 37% by mass, more preferably 24% to 35% by mass, still more preferably 24% to 30% by mass, and particularly 24% to 25% by mass. The tetraethylene glycol monobutyl ether content in the ink composition is preferably more than 1% by mass and less than 5% by mass, and more preferably 2% to 4% by mass. Thus the ejection stability and the defoaming function can be further enhanced.

As described above, the ink composition of the present embodiment is a solvent-based metallic ink composition for ink jet printing that can form a surface having a superior metallic luster by printing.

### Resin

The ink composition of the present embodiment may contain a resin. Examples of the resin include acrylic resins produced from at least either acrylic esters or methacrylic esters, styrene-acrylic resins, which are copolymers of styrene and acrylic esters or methacrylic esters, rosin-modified resins, terpene resins, modified terpene resins, polyester resins, polyamide resins, epoxy resins, vinyl chloride resins, vinyl chloride-vinyl acetate copolymers, cellulose resins (for example, cellulose acetate butyrate, hydroxypropyl cellulose), polyvinyl butyral, polyacrylic polyol, polyvinyl alcohol, polyurethane, and hydrogenated petroleum resins.

Also, nonaqueous dispersion (NAD) or nonaqueous emulsion polymer particles may be used as the resin. NAD is a liquid dispersion in which fine particles of polyurethane resin, acrylic resin or acrylic polyol resin are stably dispersed in an organic solvent.

Examples of polyurethane resin NAD include SANPRENE IB-501 and SANPRENE IB-F370, each produced by Sanyo Chemical Industries. An acrylic polyol resin NAD may be N-2043-60 MEX produced by Harima Chemicals.

Preferably, 0.1% to 10% by mass of resin emulsion is added to the ink composition from the viewpoint of further enhancing the fixability of the pigment to recording media. If the resin emulsion content is excessively high, a sufficient printing stability cannot be obtained. If the content is excessively low, the fixability is insufficient. From the same viewpoint, the resin content in the ink composition is preferably 0.05% to 1.5% by mass, more preferably 0.1% to 1.0% by mass, still more preferably 0.15% to 0.35% by mass, and particularly 0.15% to 0.25% by mass.

The resin in the ink composition is preferably at least one selected from the group consisting of polyvinyl butyral, cellulose acetate butyrate, and polyacrylic polyol, and more preferably cellulose acetate butyrate. Such a preferred composition can produce favorable effects of exhibiting high rub fastness and fixability when it is dried, and of being superior in metallic luster.

### Other Additives

The ink composition of the present embodiment may further contain other additives without particular limitation. For example, known additives may be contained if necessary, such as wetting agents (moisturizing agents), penetrants (penetration accelerators), organic solvents, antifungal agents or preservatives, rust preventives, antioxidants, thickeners, saccharides, pH modifiers, surfactants, glycerin, polyalkylene glycols, and surface conditioners.

Preferably, the ink composition contains at least one additive selected from among glycerin, polyalkylene glycols and saccharides. The total content of glycerin, polyalkylene glycols and saccharides is preferably 0.1% to 10% by mass in the ink composition. Such a preferred composition can suppress the ink from drying and prevent clogging, and thus can stabilize ink ejection and accordingly enhance the image quality of the recorded matter.

Polyalkylene glycols are linear polymers containing a repetitive structure of ether bonds in the main chain, and can be produced by, for example, ring-opening polymerization of a cyclic ether.

Exemplary alkylene glycols include polymers such as polyethylene glycol and polypropylene glycol, ethylene oxide-propylene oxide copolymers and their derivatives. Any type of copolymers, such as random copolymer, block copolymer, graft copolymer and alternating copolymer, can be used.

Preferred polyalkylene glycols may be expressed by the following chemical formula:

HO—(CₙH₂ₙO)ₘ—H

In the formula, n represents an integer of 1 to 5, and m represents an integer of 1 to 100.

The integer n of (CₙH₂ₙO)ₘ of the above formula may be a single constant or a combination of two or more numbers, within the range of n. For example, when n is 3, the (CₙH₂ₙO)ₘ is (C₃H₆O)ₘ; when n is the combination of 1 and 4, the (CₙH₂ₙO)ₘ is (CH₂O—C₄H₈O)ₘ. Also, the integer m may be a single constant or a combination of two or more numbers, within the range of m. For example, when m is the sum of 20 and 40, the (CₙH₂ₙO)ₘ may be (CH₂O)₂₀—(C₂H₄O)₄₀; when m is the sum of 10 and 30, it may be (CH₂O)₁₀—(C₄H₈O)₃₀. The integers n and m each may be arbitrarily combined within the above ranges.

Exemplary saccharides include monosaccharides, such as pentose, hexose, heptose, and octose; polysaccharides, such as disaccharides, trisaccharides, and tetrasaccharides; and derivatives of these saccharides, such as reduced derivatives including sugar alcohols and deoxy acids, oxidized derivatives including aldonic acid and uronic acid, dehydrated derivatives including glycoseen, amino acides, and thio sugars. Polysaccharides refer to a type of saccharide in a broad sense, and include compounds existing widely in the natural world, such as alginic acids, dextrin and cellulose.

### Properties of Ink Composition

The present inventors have confirmed that the phenomenon of ink bleeding on a recording medium can be avoided more effectively by controlling the surface tension and viscosity of the ink composition in a predetermined range.

The surface tension of the ink composition of the present embodiment is preferably 20 to 50 mN/m, more preferably 20 to 40 mN/m, and still more preferably 20 to 30 mN/m. When the surface tension is in this range, the phenomenon of ink bleeding on a recording medium can be avoided more effectively. The surface tension mentioned herein is a value measured by the method that will be described in Examples.

The viscosity of the ink composition of the present embodiment is preferably 8 mPa·s or less, more preferably 5 mPa·s or less, and still more preferably 2 to 5 mPa·s. When the viscosity is in this range, the phenomenon of ink bleeding on a recording medium can be avoided more effectively. The viscosity at 20° C. mentioned herein is a value measured by the method that will be described in Examples.

Preferably, the rub fastness of the ink composition of the present embodiment is in level “A”, which means that the ink is not separated in the measurement and evaluation in Examples. The rub fastness mentioned herein is measured and evaluated by the method that will be described in Examples.

The preferred value and measuring method of the glossiness of the ink composition will be described later.

The present embodiment can provide an ink composition having high metallic luster and ejection stability, particularly superior metallic luster to known ink compositions, while it can avoid bleeding out on a recording medium and maintain the viscosity and surface tension at the same levels as the known ink compositions.

### Recording Medium

The ink composition of the present embodiment is used in an ink jet recording method to from an image on a recording medium.

The recording medium may be absorbent or nonabsorbent. The ink jet recording method described below can be widely applied to various recording media from a nonabsorbent recording medium into which water-soluble ink compositions cannot penetrate to an absorbent recording medium into which water-soluble ink compositions easily penetrate.

Absorbent recording media include, but are not limited to, plane paper such as electrophotographic paper having high permeability to aqueous ink, ink jet paper having an ink absorbing layer containing silica particles or alumina particles or an ink absorbing layer made of a lipophilic polymer such as polyvinyl alcohol (PVA) or polyvinyl pyrrolidone (PVP), and art paper (coated paper) and cast-coated paper that are used ordinary offset printing and have relatively low permeability to aqueous ink.

Nonabsorbent recording media include, but are not limited to, plastic films or plates, such as those of polyvinyl chloride, polyethylene, polypropylene, and polyethylene terephthalate (PET); metal plates, such as those of iron, silver, copper, and aluminum; metal-coated metal plates or plastic films formed by vapor-depositing those metals on a metal plate or plastic film; and alloy plates, such as those of stainless steel and brass.

### Ink Jet Recording Method

In an ink jet recording method according an embodiment of the invention, recording is performed by ejecting droplets of the ink composition described above to be deposited on a recording medium.

If the recording medium does not have an ink receiving layer, it is preferable that the recording medium be heated for printing, from the viewpoint of producing superior glossiness. In this instance, the heating temperature is preferably 30 to 50° C., and more preferably 35 to 45° C.

Heating may be performed by bringing the recording medium into contact with a heat source. Heating may be performed without contact with a heat source. For example, the recording medium may be irradiated with infrared rays, microwaves (electromagnetic waves having a maximum wavelength around 2,450 MHz) or the like or blown with hot air.

Preferably, the heating is performed simultaneously with printing. In other words, the heating of a recording medium may be performed over the period of printing. The heating temperature is preferably 30 to 80° C., and more preferably 35 to 45° C., depending on the type of the recording medium.

The ink jet recording method of the present embodiment uses the above-described ink composition, and the ink composition can suppress undesired chemical reactions, degradation of glossiness, and generation of gases, even under high temperature environment.

### EXAMPLES

The embodiment of the invention will now be further described in detail with reference to Examples, and the invention is not limited to those Examples.

### Example 1

### Preparation of Metal Pigment-Dispersed Liquid

A resin layer coating liquid containing 3% by mass of cellulose acetate butyrate (butyration degree: 35% to 39%, produced by KANTO CHEMICAL) and 97% by mass of diethylene glycol diethyl ether (produced by Nippon Nyukazai) was uniformly applied onto a 100 μm thick PET film by a bar-coating method. Then, the coating was dried at 60° C. for 10 minutes to form a resin thin layer on the PET film.

Subsequently, a vapor-deposited aluminum layer having an average thickness of 20 nm was formed on the resin layer using a vacuum vapor deposition apparatus VE-1010 (manufactured by VACUUM DEVICE INC.).

Then, the resulting multilayer composite was simultaneously subjected to peeling, pulverization and dispersion in diethylene glycol diethyl ether using an ultrasonic dispersion apparatus VS-150 (manufactured by AS ONE Corporation), and thus a metal pigment-dispersed liquid was prepared which had been subjected to ultrasonic dispersion for 12 hours in total time.

The resulting metal pigment-dispersed liquid was filtered through a SUS mesh filter with an opening of 5 to remove coarse particles. Subsequently, the filtrate was placed in a round-bottom flask, and diethylene glycol diethyl ether was evaporated using a rotary evaporator. Thus the metal pigment-dispersed liquid was concentrated. Then, the concentration of the metal pigment-dispersed liquid was adjusted to yield a metal pigment-dispersed liquid containing 5% by mass of metal pigment.

The sphere-equivalent 50% average particle size (D50) of the metal pigment was measured by a light-scattering method with a laser diffraction/scattering particle size analyzer LMS-2000e manufactured by Seishin Enterprise, and the result was 1.001 μm. The largest particle size was 5.01 μl.

Furthermore, the water content in the metal pigment-dispersed liquid was measured with a micro-moisture meter FM-300A manufactured by Kett Electric Laboratory, and the result was 0.58% by mass. The water content in the diethylene glycol diethyl ether (produced by Nippon Nyukazai) was 0.38% by mass.

### Properties of Ink Compositions

Ink compositions shown in Tables 1 to 5 were prepared using the above metal pigment-dispersed liquid. The solvent and additives were mixed and dissolved to prepare an ink solvent. Then, the metal pigment-dispersed liquid was added to the ink solvent, and mixed using a magnetic stirrer at room temperature and normal pressure for 30 minutes to yield an ink composition.

The organic solvents used were diethylene glycol diethyl ether (DEGdEE), tetraethylene glycol dimethyl ether (TEGdME) and tetraethylene glycol monobutyl ether (TEGmBE) (each produced by Nippon Nyukazai.), and γ-butyrolactone (γ-BL) (produced by KANTO CHEMICAL). The resin used was cellulose acetate butyrate (CAB) (produced by KANTO CHEMICAL, butyration degree: 35% to 39%). In addition, dimethyl silicone oil KF-96-2cs (Shin-Etsu Chemical) was used as the silicone oil. The “2cs” following “KF-96” represents the kinematic viscosity at 25° C. Hence, the kinematic viscosity of KF-96-2cs is 2 cSt at 25° C. The values in Tables 1 to 5 are on a percent-by-mass basis. In each cell in the row of the additive, the upper side shows the product name, and the lower side shows the additive content.

### Examples 2 to 23

Ink compositions according to Tables 1 to 5 were prepared in the same manner as in Example 1 except that different silicone oils shown in Tables 1 to 5 were used instead of KF-96-2cs. The following silicone oils were used:
KF-96-5cs (kinematic viscosity at 25° C.: 5 cSt)
KF-96-10cs (kinematic viscosity at 25° C.: 10 cSt)
KF-96-20cs (kinematic viscosity at 25° C.: 20 cSt)
KF-96-30cs (kinematic viscosity at 25° C.: 30 cSt, up to this, each dimethyl silicone oil produced by Shin-Etsu Chemical)
KF-99 (methyl hydrogen silicone oil produced by Shin-Etsu Chemical, kinematic viscosity at 25° C.: 20 cSt)

### Comparative Examples 1 to 10

Ink compositions according to Tables 1 to 5 were prepared in the same manner as in Example 1 except that different silicone oils shown in Tables 1 to 5 were used as additives.

BYK-UV3500 (produced by BYK Japan) is also a type of silicone oil, and is, more specifically, an acrylic group-containing polyether-modified polydimethylsiloxane (kinematic viscosity at 25° C.: 650 cSt).

TABLE 1

| | | | | | | | Comparative |
|---|---|---|---|---|---|---|---|
| | Example 1 | Example 2 | Example 3 | Example 4 | Example 5 | Example 6 | Example 1 |
| Al content | 1.2 | 1.2 | 1.2 | 1.2 | 1.2 | 1.2 | 1.2 |
| Resin | 0.2 | 0.2 | 0.2 | 0.2 | 0.2 | 0.2 | 0.2 |
| DEGdEE | 70.55 | 70.55 | 70.55 | 70.55 | 70.55 | 70.55 | 70.55 |
| γ-BL | 10 | 10 | 10 | 10 | 10 | 10 | 10 |
| TEGmME | 15 | 15 | 15 | 15 | 15 | 15 | 15 |
| TEGmBE | 3 | 3 | 3 | 3 | 3 | 3 | 3 |
| Additive | KF-96-2cs | KF-96-5cs | KF-96-10cs | KF-96-20cs | KF-96-30cs | KF-99 | BYK- |
| | 0.05 | 0.05 | 0.05 | 0.05 | 0.05 | 0.05 | UV3500 |
| | | | | | | | 0.05 |

TABLE 2

| | Example | Example | Example | Example | Example | Example | Comparative |
|---|---|---|---|---|---|---|---|
| | 7 | 8 | 9 | 10 | 11 | 12 | Example 2 |
| Al content | 1.2 | 1.2 | 1.2 | 1.2 | 1.2 | 1.2 | 1.2 |
| Resin | 0.2 | 0.2 | 0.2 | 0.2 | 0.2 | 0.2 | 0.2 |
| DEGdEE | 70.5 | 70.5 | 70.5 | 70.5 | 70.5 | 70.5 | 70.5 |
| γ-BL | 10 | 10 | 10 | 10 | 10 | 10 | 10 |
| TEGmME | 15 | 15 | 15 | 15 | 15 | 15 | 15 |
| TEGmBE | 3 | 3 | 3 | 3 | 3 | 3 | 3 |
| Additive | KF-96-2cs | KF-96-5cs | KF-96-10cs | KF-96-20cs | KF-96-30cs | KF-99 | BYK- |
| | 0.1 | 0.1 | 0.1 | 0.1 | 0.1 | 0.1 | UV3500 |
| | | | | | | | 0.1 |

TABLE 3

| | Example | Example | Example | Example | Example | Example | Comparative |
|---|---|---|---|---|---|---|---|
| | 13 | 14 | 15 | 16 | 17 | 18 | Example 3 |
| Al content | 1.2 | 1.2 | 1.2 | 1.2 | 1.2 | 1.2 | 1.2 |
| Resin | 0.2 | 0.2 | 0.2 | 0.2 | 0.2 | 0.2 | 0.2 |
| DEGdEE | 70.4 | 70.4 | 70.4 | 70.4 | 70.4 | 70.4 | 70.4 |
| γ-BL | 10 | 10 | 10 | 10 | 10 | 10 | 10 |
| TEGmME | 15 | 15 | 15 | 15 | 15 | 15 | 15 |
| TEGmBE | 3 | 3 | 3 | 3 | 3 | 3 | 3 |
| Additive | KF-96-2cs | KF-96-5cs | KF-96-10cs | KF-96-20cs | KF-96-30cs | KF-99 | BYK- |
| | 0.2 | 0.2 | 0.2 | 0.2 | 0.2 | 0.2 | UV3500 |
| | | | | | | | 0.2 |

TABLE 4

| | Example | Example | Example | Example | Example | Comparative |
|---|---|---|---|---|---|---|
| | 19 | 20 | 21 | 22 | 23 | Example 4 |
| Al content | 1.2 | 1.2 | 1.2 | 1.2 | 1.2 | 1.2 |
| Resin | 0.2 | 0.2 | 0.2 | 0.2 | 0.2 | 0.2 |
| DEGdEE | 70.3 | 70.3 | 70.3 | 70.3 | 70.3 | 70.3 |
| γ-BL | 10 | 10 | 10 | 10 | 10 | 10 |
| TEGmME | 15 | 15 | 15 | 15 | 15 | 15 |
| TEGmBE | 3 | 3 | 3 | 3 | 3 | 3 |
| Additive | KF-96-2cs | KF-96-5cs | KF-96-10cs | KF-96-20cs | KF-99 | KF-96-30cs |
| | 0.3 | 0.3 | 0.3 | 0.3 | 0.3 | 0.3 |

TABLE 5

| | Comparative | Comparative | Comparative | Comparative | Comparative | Comparative |
|---|---|---|---|---|---|---|
| | Example 5 | Example 6 | Example 7 | Example 8 | Example 9 | Example 10 |
| Al content | 1.2 | 1.2 | 1.2 | 1.2 | 1.2 | 1.2 |
| Resin | 0.2 | 0.2 | 0.2 | 0.2 | 0.2 | 0.2 |
| DEGdEE | 70.1 | 70.1 | 70.1 | 70.1 | 70.1 | 70.1 |
| γ-BL | 10 | 10 | 10 | 10 | 10 | 10 |
| TEGmME | 15 | 15 | 15 | 15 | 15 | 15 |
| TEGmBE | 3 | 3 | 3 | 3 | 3 | 3 |
| Additive | KF-96-2cs | KF-96-5cs | KF-96-10cs | KF-96-20cs | KF-96-30cs | KF-99 |
| | 0.5 | 0.5 | 0.5 | 0.5 | 0.5 | 0.5 |

### Evaluation

### 1. Glossiness

The ink composition was placed in the black line of an ink jet printer EM-930C (manufactured by Seiko Epson), and solid printing was performed on a photo paper KA450PSK having an ink receiving layer manufactured by Seiko Epson at room temperature. The ink composition was ejected at 1.2 mg/cm², and the dry mass of the metal pigment was 12 μg/cm². The glossiness at 20 degrees of the resulting image was measured with a glossimeter MULTI Gloss 268 (manufactured by Konica Minolta). The results are shown in Tables 6 to 10.

### 2. Ejection Stability

The ink composition was placed in the black ink line of an ink jet printer SP-300V (manufactured by Roland DG Corporation), and solid printing was performed on a glossy PVC recording medium SV-G-610G (with gray glue, 610 mm by 20 m).

Whether ejection failure (nozzle fault) had occurred was investigated by visually observing the resulting solid image, and the ejection stability was evaluated according to the following criteria. The “nozzle fault” means that ink that should be ejected from nozzles of the print head cannot be ejected because one or some of the nozzles are clogged with the ink and affects the printed image. Evaluation levels A, B and C represent higher ejection stabilities in that order. The evaluation results are shown in Tables 6 to 10.

A: No ejection failure (nozzle fault) was observed in a print size of 50 cm×200 cm.

B: Ejection failure (nozzle fault) was partly observed (at one to three points) in a print size of 50 cm×200 cm.

C: Ejection failure (nozzle fault) was observed (at four points or more) in a print size of 50 cm×200 cm.

### 3. Viscosity

The viscosity of each ink composition was measured at 25° C. with a rheometer MCR300 (manufactured by Paar Physca). The results are shown in Tables 6 to 10.

### 4. Surface Tension

The surface tension was measured at 20° C. by a platinum plate method with an automatic surface tensiometer (CBVP-A3, manufactured by Kett Electric Laboratory). The results are shown in Tables 6 to 10.

TABLE 6

| | | | | | | | Comparative |
|---|---|---|---|---|---|---|---|
| | | | | | | | Example |
| | Example 1 | Example 2 | Example 3 | Example 4 | Example 5 | Example 6 | 1 |
| Glossiness | 300 | 310 | 288 | 261 | 260 | 270 | 221 |
| Viscosity | 3.09 | 3.16 | 3.04 | 3.15 | 3.13 | 3.15 | 3.05 |
| (mPa · s) | | | | | | | |
| Surface | 29.1 | 28.6 | 27.2 | 25.6 | 25.1 | 25.2 | 25.5 |
| tension | | | | | | | |
| (mN/m) | | | | | | | |
| Ejection | A | A | B | B | B | B | A |
| stability | | | | | | | |

TABLE 7

| | | | | | | | Comparative |
|---|---|---|---|---|---|---|---|
| | Example 7 | Example 8 | Example 9 | Example 10 | Example 11 | Example 12 | Example 2 |
| Glossiness | 302 | 312 | 297 | 279 | 276 | 269 | 239 |
| Viscosity | 3.09 | 3.08 | 3.06 | 3.13 | 3.16 | 3.18 | 3.06 |
| (mPa · s) | | | | | | | |
| Surface | 28.9 | 28.4 | 26.6 | 25.2 | 24.6 | 25.5 | 25.3 |
| tension | | | | | | | |
| (mN/m) | | | | | | | |
| Ejection | A | A | B | B | B | B | A |
| stability | | | | | | | |

TABLE 8

| | | | | | | | Comparative |
|---|---|---|---|---|---|---|---|
| | Example 13 | Example 14 | Example 15 | Example 16 | Example 17 | Example 18 | Example 3 |
| Glossiness | 310 | 322 | 297 | 288 | 287 | 283 | 251 |
| Viscosity | 3.09 | 3.08 | 3.06 | 3.13 | 3.16 | 3.13 | 3.03 |
| (mPa · s) | | | | | | | |
| Surface | 28.9 | 28.4 | 26.6 | 25.2 | 24.6 | 25.5 | 25.6 |
| tension | | | | | | | |
| (mN/m) | | | | | | | |
| Ejection | A | A | B | B | B | B | A |
| stability | | | | | | | |

TABLE 9

| | Example | Example | Example | Example | Example | Comparative |
|---|---|---|---|---|---|---|
| | 19 | 20 | 21 | 22 | 23 | Example 4 |
| Glossiness | 280 | 278 | 256 | 254 | 256 | 239 |
| Viscosity | 3.08 | 3.04 | 3.08 | 3.06 | 3.12 | 3.08 |
| (mPa · s) | | | | | | |
| Surface | 29.0 | 28.3 | 27.5 | 25.3 | 25.5 | 25.3 |
| tension | | | | | | |
| (mN/m) | | | | | | |
| Ejection | B | B | B | B | B | B |
| stability | | | | | | |

TABLE 10

| | Comparative | Comparative | Comparative | Comparative | Comparative | Comparative |
|---|---|---|---|---|---|---|
| | Example 5 | Example 6 | Example 7 | Example 8 | Example 9 | Example 10 |
| Glossiness | 231 | 227 | 191 | 199 | 192 | 195 |
| Viscosity | 3.09 | 3.06 | 3.05 | 3.06 | 3.06 | 3.13 |
| (mPa · s) | | | | | | |
| Surface | 29.3 | 28.1 | 27.3 | 25.5 | 25.2 | 25.3 |
| tension | | | | | | |
| (mN/m) | | | | | | |
| Ejection | C | C | C | C | C | C |
| stability | | | | | | |

Tables 6 to 10 show that an ink composition containing a specific amount of silicone oil having a kinematic viscosity of 2 to 30 cSt can exhibit high glossiness and ejection stability, particularly superior glossiness, while maintaining the viscosity and surface tension.

What is claimed is:

1. An ink composition comprising:
an organic solvent;
a metal pigment; and
a silicone oil having a kinematic viscosity of 2 to 30 cSt,
wherein the silicone oil content is 0.01% by mass or more and less than 0.5% by mass relative to the total mass of the ink composition, and
the value of expression (1) is 0.1 or more and less than 9.0:
[Kinematic viscosity of silicone oil on a cSt basis]×[silicone oil content on a percent-by-mass basis] (1)

2. The ink composition according to claim 1, wherein the silicone oil has a kinematic viscosity of 2 to 10 cSt at 25° C.

3. The ink composition according to claim 1, wherein the organic solvent is a mixture containing at least two compounds selected from the group consisting of alkylene glycol dialkyl ethers, alkylene glycol monoalkyl ethers, and lactones.

4. The ink composition according to claim 3, wherein the organic solvent contains diethylene glycol diethyl ether, γ-butyrolactone, tetraethylene glycol monomethyl ether, and tetraethylene glycol monobutyl ether.

5. The ink composition according to claim 1, wherein the silicone oil contains at least one of dimethyl silicone oil and methyl hydrogen silicone oil.

6. The ink composition according to claim 1, wherein the metal pigment contains at least one of aluminum and aluminum alloys.

7. The ink composition according to claim 1, wherein the metal pigment is prepared by pulverizing a vapor-deposited metal film.

8. The ink composition according to claim 1, wherein the ink composition has a surface tension of 20 mN/m to 50 mN/m.

9. The ink composition according to claim 1, wherein the ink composition has a viscosity of 8 mPa·s or less at 20° C.
